(19) United States
(12) Patent Application Publication
(10) Pub. No.: US 2018/0106953 A1
(43) Pub. Date: Apr. 19, 2018

(54) LIGHT-EMITTING DEVICE

(71) Applicants: Radiant Opto-Electronics (Suzhou) Co.,Ltd., Jiangsu (CN); Radiant Opto-Electronics Corporation, Kaohsiung (TW)

(72) Inventors: Guo-Hao HUANG, KAOHSIUNG (TW); Kun-Feng CHEN, KAOHSIUNG (TW); Ko-Yu HSIAO, KAOHSIUNG (TW)

(21) Appl. No.: 15/706,784

(22) Filed: Sep. 18, 2017

Related U.S. Application Data
(63) Continuation of application No. PCT/CN2016/102327, filed on Oct. 18, 2016.

(51) Int. Cl. F21V 8/00

(52) U.S. Cl. CPC G02B 6/0063; G02B 6/0036; G02B 6/0035; G02B 6/0045

(57) ABSTRACT

A light-emitting device is provided, and includes a light guide plate and a light source. The light guide plate includes a main body, in which the main body has a light-incident surface. The light source is disposed adjacent to the light-incident surface. The light-emitting device is selectively disposed in different arrangements. When the light-emitting device is disposed in a first arrangement, the light-emitting device is able to provide a first light-emitting function towards a first direction and to provide a second light-emitting function towards a second direction. When the light-emitting device is disposed in a second arrangement, the second light-emitting function towards the second direction is changed, and the first light-emitting function towards the first direction is also changed.

### RELATED APPLICATIONS

This application is a continuation application of International Application No. PCT/CN2016/102327 filed on Oct. 18, 2016, which is incorporated herein by reference.

### BACKGROUND

### Field of Invention

The present invention relates to a light-emitting device. More particularly, the present invention relates to a light-emitting device which has different light-emitting functions on different sides.

### Description of Related Art

Lamps become more diversified to meet market requirements. One of conventional lamps is a hanging transparent lamp which can emit light beams towards a ceiling and a ground floor simultaneously, so as to achieve the purpose of better appearance and illumination.

However, the conventional hanging transparent lamp merely has a limited light-emitting function, and a ratio between a light-emitting amount towards the ceiling and a light-emitting amount towards the ground floor is fixed and cannot be adjusted, thus failing to satisfy different users' requirements.

### SUMMARY

An object of the invention is to provide a light-emitting device which has a function of adjusting light-emitting amount, light-emitting colors and/or light directivities emitted from different sides of the light-emitting device.

According to the aforementioned objects, the present invention provides a light-emitting device. The light-emitting device includes a light guide plate and a light source. The light guide plate includes a main body, in which the main body has a light-incident surface. The light source is disposed adjacent to the light-incident surface. The light-emitting device is selectively disposed in one of different arrangements. When the light-emitting device is disposed in a first arrangement, the light-emitting device is able to provide a first light-emitting function towards a first direction and to provide a second light-emitting function towards a second direction. When the light-emitting device is disposed in a second arrangement, the second light-emitting function towards the second direction is changed, and the first light-emitting function towards the first direction is also changed.

According to an embodiment of the present invention, the main body further includes a first light-emitting surface and a second light-emitting surface. The first light-emitting surface is connected to the light-incident surface, in which the first light-emitting surface has the first light-emitting function. The second light-emitting surface is connected to the light-incident surface and is opposite to the first light-emitting surface, in which the second light-emitting surface has the second light-emitting function.

According to an embodiment of the present invention, the light guide plate further includes plural first reflecting structures disposed on one of the first light-emitting surface and the second light-emitting surface.

According to an embodiment of the present invention, the light guide plate further includes plural second reflecting structures disposed on the other one of the first light-emitting surface and the second light-emitting surface. An inherent type or an arrangement density of each of the second reflecting structures is different from an inherent type or an arrangement density of each of the first reflecting structures.

According to an embodiment of the present invention, the main body further has a first light-emitting surface and a second light-emitting surface, in which the first light-emitting surface is connected to the light-incident surface, and the second light-emitting surface is connected to the light-incident surface and is opposite to the first light-emitting surface. The light guide plate further includes at least one light-adjusting member, and the at least one light-adjusting member is disposed on the first light-emitting surface and/or the second light-emitting surface so as to provide the first light-emitting surface with the first light-emitting function, and the second light-emitting surface with the second light-emitting function.

According to an embodiment of the present invention, the light-adjusting member includes a first optical film disposed on one of the first light-emitting surface and the second light-emitting surface, and the first optical film includes plural first optical structures.

According to an embodiment of the present invention, the light-adjusting member further includes a second optical film disposed on the other one of the first light-emitting surface and the second light-emitting surface, and the second optical film includes plural second optical structures. An inherent type or an arrangement density of each of the second optical structures is different from an inherent type or an arrangement density of each of the first optical structures.

According to an embodiment of the present invention, the light-adjusting member includes at least one prism film disposed on a side of the first light-emitting surface and/or a side of the second light-emitting surface.

According to an embodiment of the present invention, the light-adjusting member includes at least one color filter disposed on a side of the first light-emitting surface and/or the second light-emitting surface.

According to an embodiment of the present invention, the light guide plate further includes an inclined structure disposed on one end of the main body away from the light-incident surface, in which the inclined structure has an inclined surface, and the inclined surface is inclined relative to the first light-emitting surface and the second light-emitting surface.

According to an embodiment of the present invention, the light guide plate further includes a third reflecting structure disposed on the inclined surface.

According to an embodiment of the present invention, when the light-emitting device is disposed in the first arrangement, the first light-emitting surface of the light guide plate faces towards the first direction and the second light-emitting surface of the light guide plate faces towards the second direction. When the light-emitting device is disposed in the second arrangement, the first light-emitting surface of the light guide plate faces towards the second direction and the second light-emitting surface of the light guide plate faces towards the first direction.

According to an embodiment of the present invention, the second light-emitting function is different from the first light-emitting function, and the second direction is different from the first direction.

According to an embodiment of the present invention, the first light-emitting function involves a first luminous property, a first chromaticity property and a first directional property. The second light-emitting function involves a second luminous property, a second chromaticity property and a second directional property. The second light-emitting function is different from the first light-emitting function in that at least one of the first luminous property, the first chromaticity property and the first directional property is different from at least one of the second luminous property, the second chromaticity property and the second directional property.

According to the aforementioned embodiments of the present invention, the first light-emitting function of the light-emitting device towards the first direction and the second light-emitting function of the light-emitting device towards the second direction can be changed by varying an orientation and/or a configuration of the light guide plate, such as changing the orientation in which the light guide plate is situated or adding the light-adjusting member to the light guide plate. Therefore, a user may change different light-emitting functions by adjusting the arrangement of the light-emitting device, so as to meet multiple the user's requirements.

### BRIEF DESCRIPTION OF THE DRAWINGS

The invention can be more fully understood by reading the following detailed description of the embodiment, with reference made to the accompanying drawings as follows:

FIG. 1 is a schematic diagram showing a light-emitting device disposed in a first arrangement in accordance with a first embodiment of the present invention;

FIG. 2 is a schematic diagram showing the light-emitting device disposed in a second arrangement in accordance with the first embodiment of the present invention;

FIG. 3 is a schematic diagram showing a light-emitting device disposed in a first arrangement in accordance with a second embodiment of the present invention;

FIG. 4 is a schematic diagram showing the light-emitting device disposed in a second arrangement in accordance with the second embodiment of the present invention;

FIG. 5 is a schematic diagram showing a light-emitting device disposed in a first arrangement in accordance with a third embodiment of the present invention;

FIG. 6 is a schematic diagram showing the light-emitting device disposed in a second arrangement in accordance with the third embodiment of the present invention;

FIG. 7 is a schematic diagram showing a light-emitting device disposed in a first arrangement in accordance with a fourth embodiment of the present invention;

FIG. 8 is a schematic diagram showing the light-emitting device disposed in a second arrangement in accordance with the fourth embodiment of the present invention;

FIG. 9 is a schematic diagram showing a light-emitting device disposed in a first arrangement in accordance with a fifth embodiment of the present invention;

FIG. 10 is a schematic diagram showing the light-emitting device disposed in a second arrangement in accordance with the fifth embodiment of the present invention;

FIG. 11 is a schematic diagram showing a light-emitting device disposed in a first arrangement in accordance with a sixth embodiment of the present invention; and

FIG. 12 is a schematic diagram showing the light-emitting device disposed in a second arrangement in accordance with the sixth embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

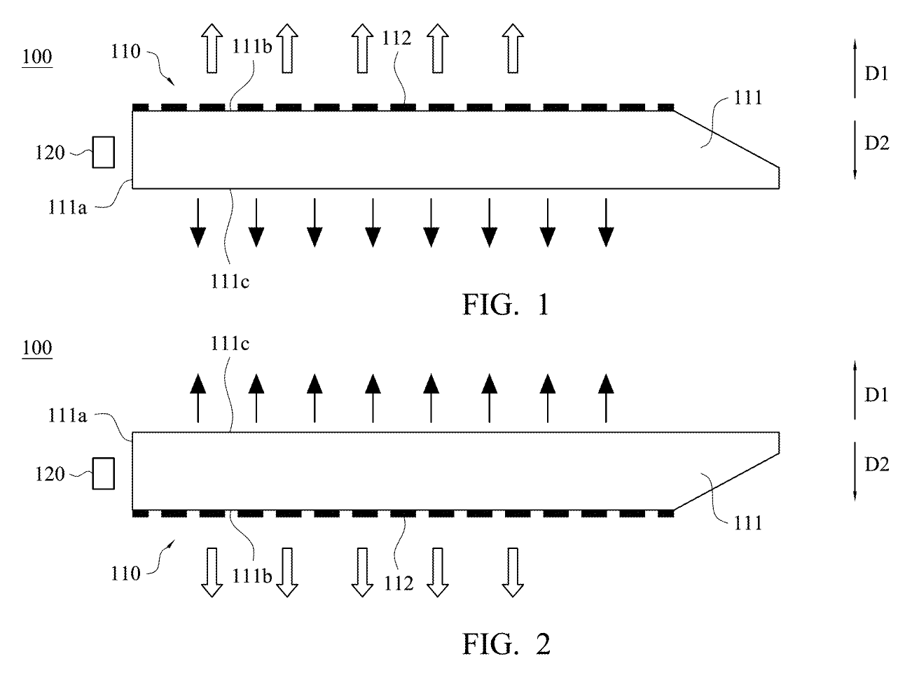

Simultaneously referring to FIG. 1 and FIG. 2, FIG. 1 and FIG. 2 are schematic diagrams showing a light-emitting device 100 respectively disposed in a first arrangement and a second arrangement in accordance with a first embodiment of the present invention. The light-emitting device 100 of the present embodiment mainly includes a light guide plate 110 and a light source 120. The light guide plate 110 includes a main body 111, and the main body 111 has a light-incident surface 111a. The light source 120 is disposed adjacent to the light-incident surface 111a, so as to emit light into the light guide plate 110. In the present embodiment, the light-emitting device 100 is selectively disposed in one of different arrangements. In some embodiments, the arrangement of the light-emitting device 100 can be changed by disposing the light guide plate 110 of the light-emitting device 100 in different orientations, or forming the light guide plate 110 of the light-emitting device 100 in different configurations, thereby generating different light-emitting effects.

Referring to FIG. 1 again, when the light-emitting device 100 is disposed in a first arrangement, the light-emitting device 100 is able to provide a first light-emitting function towards a first direction D1 and to provide a second light-emitting function towards a second direction D2. When the light-emitting device 100 is disposed in a second arrangement, the second light-emitting function towards the second direction D2 is changed, and the first light-emitting function towards the first direction D1 is also changed. It is noted that, the “light-emitting function” described herein involves luminous properties, chromaticity properties and/or directional properties. If one or more than one of the luminous properties, chromaticity properties and directional properties is/are changed, the light-emitting function is changed accordingly. In one example, the luminous properties may include a light-emitting amount, the chromaticity properties may include a light-emitting color, and the directional properties may include a light directivity.

In the present embodiment, the main body 111 of the light guide plate 110 further has a first light-emitting surface 111b and a second light-emitting surface 111c. The first light-emitting surface 111b and the second light-emitting surface 111c are respectively connected two opposite sides of the light-incident surface 111a. The first light-emitting surface 111b has the first light-emitting function, and the second light-emitting surface 111c has the second light-emitting function. In the present embodiment, there are plural first reflecting structures 112 disposed on the first light-emitting surface 111b. Therefore, a portion of light provided by the light source 120 can emit from the first light-emitting surface 111b, and a portion of light provided by the light source 120 can first be reflected by the first reflecting structures 112 and emits from second light-emitting surface 111c. Therefore, besides light directly provided by the light source 120, light emitted from the second light-emitting surface 111c further includes light reflected by the first reflecting structures 112, so that light-emitting amount emitted from the second light-emitting surface 111c is greater than light-emitting amount emitted from the first light-emitting surface 111b. In other words, the first light-emitting function of the first light-emitting surface 111b is different from the second light-emitting function of the second light-emitting surface 111c. In one embodiment, the first reflecting structures 112 can be disposed on the first light-emitting surface 111b by printing or coating process. In one example, a light emitting ratio of the first light-emitting surface 111b to the second light-emitting surface 111c can be adjusted by varying structural shapes and arrangement densities of the first reflecting structures 112.

As shown in FIG. 1, when the light-emitting device 100 is disposed in the first arrangement, the light guide plate 110 is disposed in a first orientation, in which the first light-emitting surface 111b of the light guide plate 110 faces towards the first direction D1 to provide the first light-emitting function, and the second light-emitting surface 111c of the light guide plate 110 faces towards the second direction D2 to provide the second light-emitting function. As shown in FIG. 2, when the light-emitting device 100 is disposed in the second arrangement, the light guide plate 110 is disposed in a second orientation, in which the second light-emitting surface 111c of the light guide plate 110 faces towards the first direction D1 to provide the second light-emitting function, and the first light-emitting surface 111b of the light guide plate 110 faced in the second direction D2 to provide the first light-emitting function. Therefore, light-emitting functions towards the first direction D1 and the second direction D2 can be changed by adjusting the orientations of the light guide plate 110. In other words, light-emitting functions towards the first direction D1 and the second direction D2 can be changed by adjusting the arrangement of the light-emitting device 100.

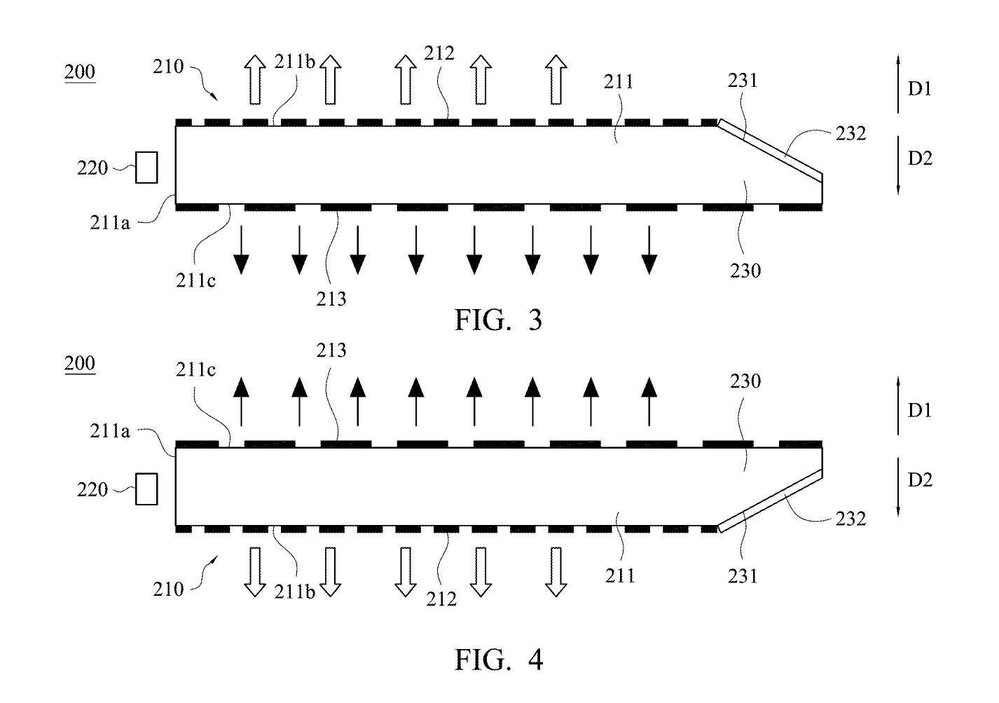

In the present invention, the light-emitting device may have different designs. Simultaneously referring to FIG. 3 and FIG. 4, FIG. 3 and FIG. 4 are schematic diagrams showing a light-emitting device 200 respectively disposed in a first arrangement and a second arrangement in accordance with a second embodiment of the present invention. The light-emitting device 200 of the present embodiment mainly includes a light guide plate 210 and a light source 220. The light guide plate 210 includes a main body 211, and the main body 211 has a light-incident surface 211a, a first light-emitting surface 211b and a second light-emitting surface 211c. The first light-emitting surface 211b and the second light-emitting surface 211c are respectively connected to two opposite sides of the light-incident surface 211a. The light source 220 is disposed adjacent to the light-incident surface 211a, so as to emit light into the light guide plate 210. In the present embodiment, the first light-emitting surface 211b has a first light-emitting function, and the second light-emitting surface 211c has a second light-emitting function.

As shown in FIG. 3 and FIG. 4, there are plural first reflecting structures 212 disposed on the first light-emitting surface 211b, and there are plural second reflecting structures 213 disposed on the second light-emitting surface 211c. An inherent type or an arrangement manner of each of the second reflecting structures 213 is different from an inherent type or an arrangement manner of each of the first reflecting structures 212. It is noted that, the “inherent type” used herein means structural features of the first reflecting structures 212 and the second reflecting structures 213, such as structural shapes, heights, depths or widths of the first strip structures 520 and the second strip structures 530. Therefore, light-emitting amount provided by the light source 220 and emitting from the second light-emitting surface 211c is different from light-emitting amount provided by the light source 220 and emitting from the first light-emitting surface 211b, so that a first luminous property of the first light-emitting surface 211b is different from a second luminous property generated of the second light-emitting surface 211c. Therefore, the first light-emitting function of the first light-emitting surface 211b is different from the second light-emitting function of the second light-emitting surface 211c.

In the present embodiment, the light guide plate 210 further includes an inclined structure 230, and the inclined structure 230 is disposed on a side of main body 211 away from the light-incident surface 211a. The inclined structure 230 has an inclined surface 231 which is inclined relative to the first light-emitting surface 211b and the second light-emitting surface 211c. In the present embodiment, an included angle between the inclined surface 231 and the second light-emitting surface 211c is an acute angle. Therefore, after a portion of light generated from the light source 220 is reflected by the inclined surface 231 and emits from the second light-emitting surface 211c, the light-emitting amount emitted from the second light-emitting surface 211c is changed. In other embodiments, there are plural third reflecting structure 232 disposed on the inclined surface 231, in which the third reflecting structure 232 are used to change the light-emitting amount emitted from the second light-emitting surface 211c. In one embodiment, light-emitting amount emitted from the second light-emitting surface 211c can also be changed by adjusting the slope of the inclined surface 231.

In some embodiments, the first reflecting structures 212, the second reflecting structures 213 and the third reflecting structure 232 are formed by a printing or coating process. Moreover, a light emitting ratio of the first light-emitting surface 211b to the second light-emitting surface 211c can be adjusted by varying structural shapes and arrangement densities of the first reflecting structures 212, the second reflecting structures 213 and the third reflecting structure 232.

As shown in FIG. 3, when the light-emitting device 200 is disposed in a first arrangement, the light guide plate 210 is disposed in a first orientation, in which the first light-emitting surface 211b of the light guide plate 210 faces towards the first direction D1 to provide the first light-emitting function, and the second light-emitting surface 211c of the light guide plate 210 faces towards the second direction D2 to provide the second light-emitting function. As shown in FIG. 4, when the light-emitting device 200 is disposed in a second arrangement, the light guide plate 210 is disposed in a second orientation, in which the second light-emitting surface 211c of the light guide plate 210 faces towards the first direction D1 to provide the second light-emitting function, and the first light-emitting surface 211b of the light guide plate 210 faces towards the second direction D2 to provide the first light-emitting function. Therefore, light-emitting functions towards the first direction D1 and the second direction D2 can be changed by adjusting the orientations of the light guide plate 210. In other words, light-emitting functions towards the first direction D1 and the second direction D2 can be changed by adjusting the arrangement of the light-emitting device 200.

In the aforementioned embodiments, the first reflecting structures, the second reflecting structures and the third reflecting structure are directly disposed on the main body of the light guide plate. Therefore, the light-emitting functions respectively towards the first direction and the second direction can be changed by adjusting the orientations of the light guide plate. In other embodiments, the light-emitting functions can be changed without adjusting the orientations of the light guide plate. Instead, the light-emitting functions can be changed by forming the light guide plate of the light-emitting device in different configurations.

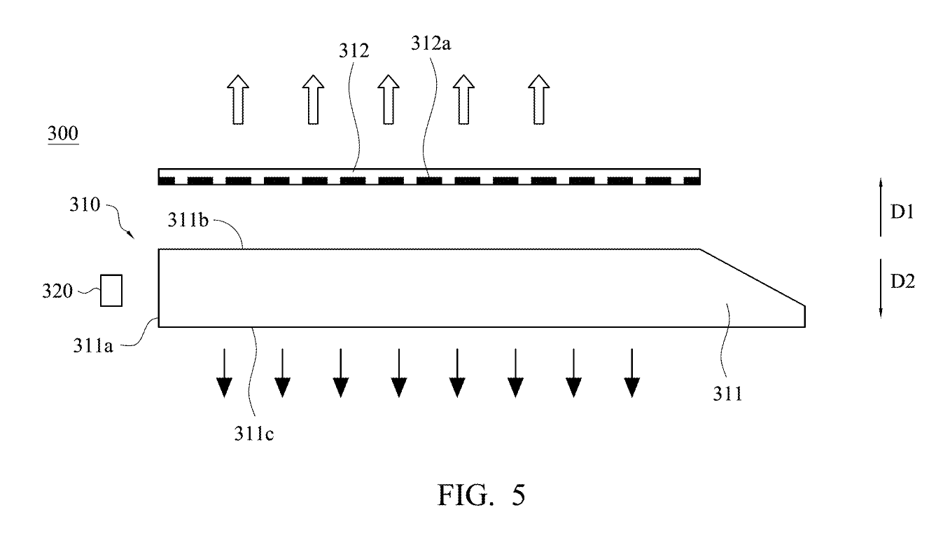

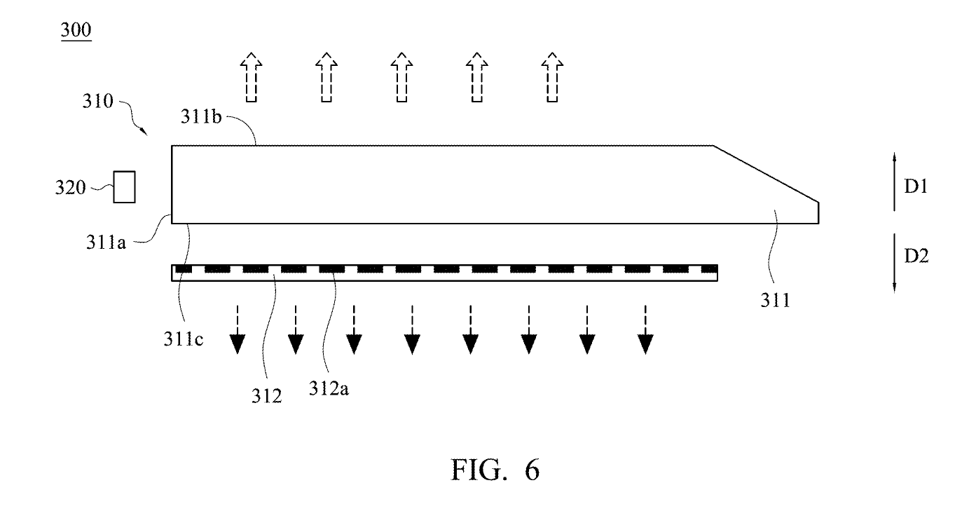

Simultaneously referring to FIG. 5 and FIG. 6, FIG. 5 and FIG. 6 are schematic diagrams showing a light-emitting device 300 respectively disposed in a first arrangement and a second arrangement in accordance with a third embodiment of the present invention. The light-emitting device 300 of the present embodiment mainly includes a light guide plate 310 and a light source 320. The light guide plate 310 includes a main body 311, and the main body 311 has a light-incident surface 311a, a first light-emitting surface 311b and a second light-emitting surface 311c. The first light-emitting surface 311b and the second light-emitting surface 311c are respectively connected to two opposite sides of the light-incident surface 311a. The light source 320 is disposed adjacent to the light-incident surface 311a, so as to emit light into the light guide plate 310. In one present embodiment, the light guide plate 310 includes a light-adjusting member which can be disposed on the first light-emitting surface 311b or the second light-emitting surface 311c. The light-adjusting member of the present embodiment includes a first optical film 312, and the first optical film 312 has plural first optical structures 312a. The first optical structures 312a are mainly used to reflect light so as to distribute light quantities respectively emitted from the first light-emitting surface 311b and the second light-emitting surface 311c. In one embodiment, the structural shapes and arrangement densities of the first optical structures 312a can be designed according to different requirements.

In some embodiments, the arrangement of the light-emitting device 300 can be changed by forming the light guide plate 310 of the light-emitting device 300 in different configurations, thereby generating different light-emitting effects. Referring to FIG. 5 again, when the light-emitting device 300 is disposed in the first arrangement, the light guide plate 310 is formed in a first configuration, in which the first optical film 312 is disposed on the first light-emitting surface 311b. Therefore, one portion of light emitted from the first light-emitting surface 311b can pass through the first optical film 312, and the other portion of light emitted from the first light-emitting surface 311b is reflected by the first optical film 312 and emits from the second light-emitting surface 311c, thereby providing the light guide plate 310 with the first light-emitting function towards the first direction D1. In addition, light emitted from the second light-emitting surface 311c includes light directly provided by the light source 320 as well as light reflected by the first optical film 312, thereby providing the light guide plate 310 with the second light-emitting function towards the second direction D2. Referring to FIG. 6, when the light-emitting device 300 is disposed in the second arrangement, the light guide plate 310 is formed in a second configuration, in which the first optical film 312 is disposed on the second light-emitting surface 311c. Therefore, one portion of light emitted from the second light-emitting surface 311c can pass through the first optical film 312, and the other portion of light is reflected by the first optical film 312 and emits from the first light-emitting surface 311b, so that the second light-emitting function towards the second direction D2 of the light guide plate 310 is changed accordingly. Similarly, light emitted from the first light-emitting surface 311b includes light directly provided by the light source 320 as well as light reflected by the first optical film 312, so that the first light-emitting function towards the first direction D1 of the light guide plate 310 is also changed.

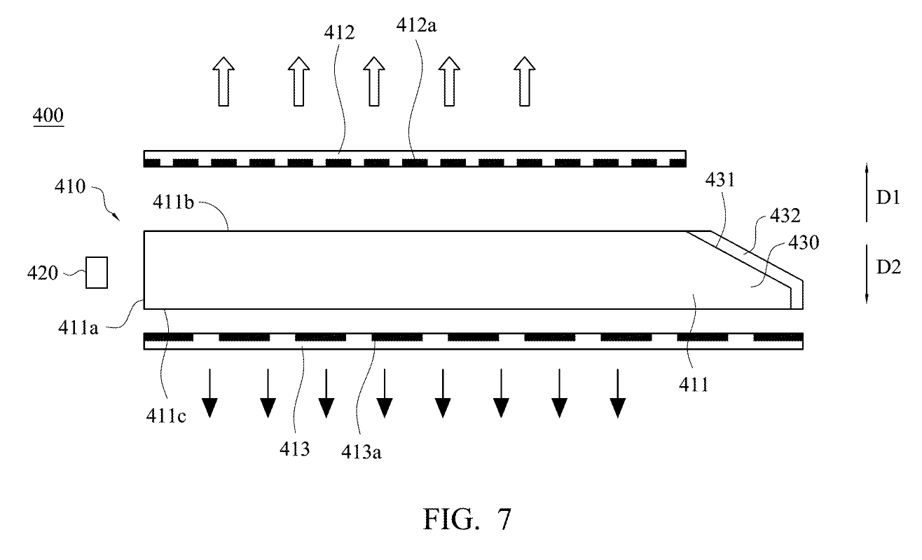

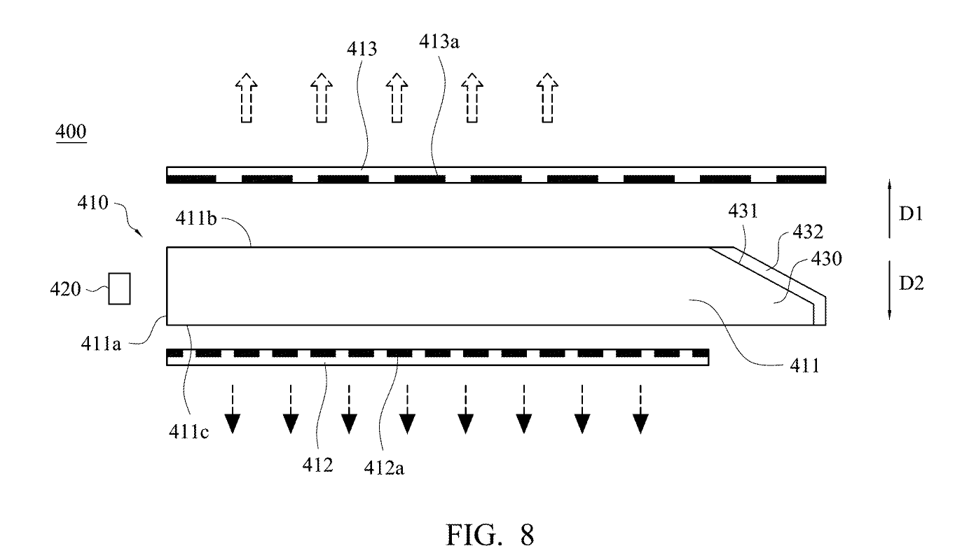

In the present invention, the light-adjusting member may have different designs. Simultaneously referring to FIG. 7 and FIG. 8, FIG. 7 and FIG. 8 are schematic diagrams showing a light-emitting device 400 respectively disposed in a first arrangement and a second arrangement in accordance with a fourth embodiment of the present invention. The light-emitting device 400 of the present embodiment mainly includes a light guide plate 410 and a light source 420. The light guide plate 410 includes a main body 411, and the main body 411 has a light-incident surface 411a, a first light-emitting surface 411b and a second light-emitting surface 411c. The first light-emitting surface 411b and the second light-emitting surface 411c are respectively connected to two opposite sides of the light-incident surface 411a. The light source 420 is disposed adjacent to the light-incident surface 411a, so as to emit light into the light guide plate 410.

The light guide plate 410 of the present embodiment includes a light-adjusting member, and the light-adjusting member includes a first optical film 412 and a second optical film 413. In addition, there are plural first optical structures 412a disposed on the first optical film 412, and there are second optical structures 413a disposed on the second optical film 413. Moreover, an inherent type or an arrangement manner of each of the second optical structures 413a is different from an inherent type or an arrangement manner of each of the first optical structures 412a. Therefore, the light-emitting amount emitted from the first optical film 412 is different from the light-emitting amount emitted from the second optical film 413. It is noted that, the designs and the functions of the first optical structures 412a and the second optical structures 413a are similar to those of the first optical structures 312a, and therefore will not be described again herein.

Referring to FIG. 7 and FIG. 8 again, in the present embodiment, the light guide plate 410 further includes an inclined structure 430, and the inclined structure 430 is disposed on a side of main body 411 away from the light-incident surface 411a. The inclined structure 430 has an inclined surface 431 which is inclined relative to the first light-emitting surface 411b and the second light-emitting surface 411c. In the present embodiment, an included angle between the inclined surface 431 and the second light-emitting surface 411c is an acute angle. Therefore, after a portion of light generated from the light source 420 is reflected by the inclined surface 431 and emits from the second light-emitting surface 411c, quantity of the light emitted from the second light-emitting surface 411c is changed. In other embodiments, there are plural third reflecting structure 432 disposed on the inclined surface 431, so that the light-emitting amount emitted from the second light-emitting surface 411c can be changed. In one embodiment, light-emitting amount emitted from the second light-emitting surface 411c can also be changed by adjusting the slope of the inclined surface 431.

In some embodiments, the arrangement of the light-emitting device 400 can be changed by forming the light guide plate 410 of the light-emitting device 400 in different configurations, thereby generating different light-emitting effects. Referring to FIG. 7, when the light-emitting device 400 is disposed in the first arrangement, the light guide plate 410 is formed in a first configuration, in which the first optical film 412 is disposed on the first light-emitting surface 411b, and the second optical film 413 is disposed on the second light-emitting surface 411c, thereby providing the light guide plate 410 with the first light-emitting function towards the first direction D1 and the second light-emitting function towards the second direction D2. As shown in FIG. 8, when the light-emitting device 400 is disposed in the second arrangement, the light guide plate 410 is formed in a second configuration, in which the first optical film 412 is disposed on the second light-emitting surface 411c, and the second optical film 413 is disposed on the first light-emitting surface 411b, so that the first light-emitting function towards the first direction D1 of the light guide plate 410 is changed, and the second light-emitting function towards the second direction D2 of the light guide plate 410 is also changed.

It is noted that, the optical film is merely used as an example of the light-adjusting member which can adjust light-emitting amount and light luminance respectively emitting towards the first direction and the second direction. In other embodiments, the light-adjusting member can be a color filter which has a function of adjusting light-emitting color.

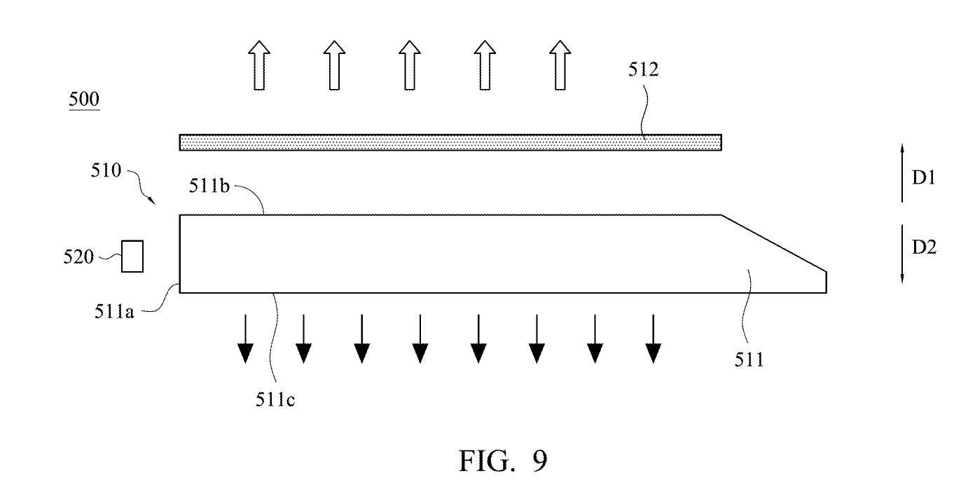

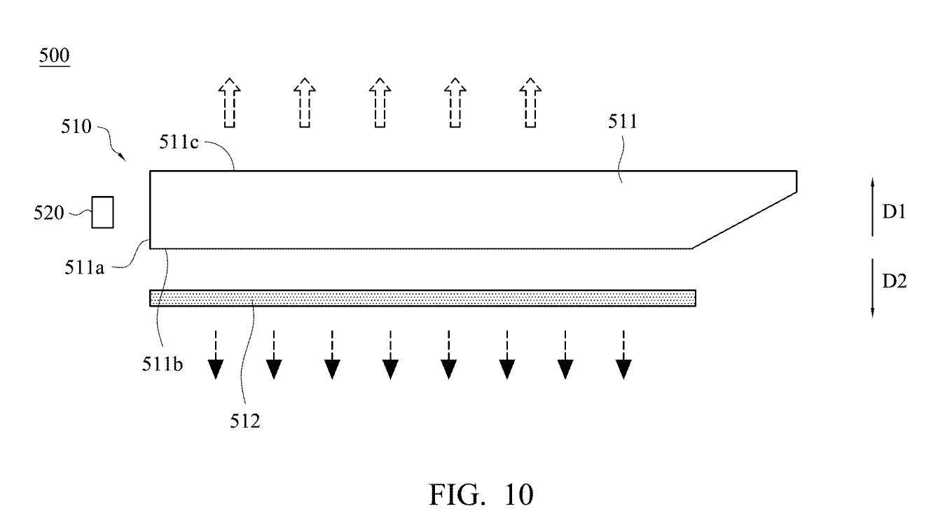

Simultaneously referring to FIG. 9 and FIG. 10, FIG. 9 and FIG. 10 are schematic diagrams showing a light-emitting device 500 respectively disposed in a first arrangement and a second arrangement in accordance with a fifth embodiment of the present invention. The light-emitting device 500 of the present embodiment mainly includes a light guide plate 510 and a light source 520. The light guide plate 510 includes a main body 511, and the main body 511 has a light-incident surface 511a, a first light-emitting surface 511b and a second light-emitting surface 511c. The first light-emitting surface 511b and the second light-emitting surface 511c are respectively connected to two opposite sides of the light-incident surface 511a. The light source 520 is disposed adjacent to the light-incident surface 511a, so as to emit light into the light guide plate 510.

The light guide plate 510 of the present embodiment includes a light-adjusting member. The light-adjusting member of the present embodiment includes a color filter 512 which is disposed on the first light-emitting surface 511b. Therefore, after light is emitted from the first light-emitting surface 511b and passes through the color filter 512, the light is changed into a different color, such that a first chromaticity property of light emitted from the color filter 512 is different from a second chromaticity property of light emitted from the second light-emitting surface 511c.

In some embodiments, the arrangement of the light-emitting device 500 can be changed by disposing the light guide plate 510 in different orientations, thereby generating different light-emitting effects. As shown in FIG. 9, when the light-emitting device 500 is disposed in the first arrangement, the light guide plate 510 is disposed in a first orientation, in which the first light-emitting surface 511b of the light guide plate 510 faces towards the first direction D1, and the second light-emitting surface 511c of the light guide plate 510 faces towards the second direction D2. The color filter 512 is disposed on the first light-emitting surface 511b. Therefore, after light is emitted from the first light-emitting surface 511b and passes through the color filter, the light is changed into a different color, thereby providing the light guide plate 510 with the first light-emitting function towards the first direction D1. Moreover, light provided by the light source 520 emitting from the second light-emitting surface 511c provides the light guide plate 510 with the second light-emitting function towards the second direction D2. As shown in FIG. 10, when the light-emitting device 500 is disposed in the second arrangement, the light guide plate 510 is disposed in a second orientation, in which the first light-emitting surface 511b of the light guide plate 510 faces towards the second direction D2, and the second light-emitting surface 511c of the light guide plate 510 faces towards first direction D1. Moreover, the color filter 512 is disposed on the first light-emitting surface 511b. Therefore, light provided by the light source 520 can be emitted from the second light-emitting surface 511c towards the first direction D1, so that the first light-emitting function of the light guide plate 510 towards the first direction D1 is changed. In addition, light emitted from the first light-emitting surface 511b and passing through the color filter 512 is emitted towards the second direction D2, so that the second light-emitting function of the light guide plate 510 towards the second direction D2 is also changed.

In other embodiments, when the light-emitting device 500 is disposed in the first arrangement, the color filter 512 also can be disposed on the second light-emitting surface 511c. Moreover, when the light-emitting device 500 is disposed in the second arrangement, the color filter 512 is disposed on the first light-emitting surface 511b, thereby changing the first light-emitting function of the light guide plate 510 towards the first direction and the second light-emitting function of the light guide plate 510 towards the second direction. In other embodiments, the color filter 512 includes a first color filter and a second color filter. When the light-emitting device 500 is disposed in the first arrangement, the first color filter is disposed on the first light-emitting surface 511b, and the second color filter is disposed on the second light-emitting surface 511c. Moreover, when the light-emitting device 500 is disposed in the second arrangement, the first color filter is disposed on the second light-emitting surface 511c, and the second color filter is disposed on the first light-emitting surface 511b, so that the first light-emitting function of the light guide plate 510 towards the first direction D1 and the second light-emitting function of the light guide plate 510 towards the second direction D2 are changed.

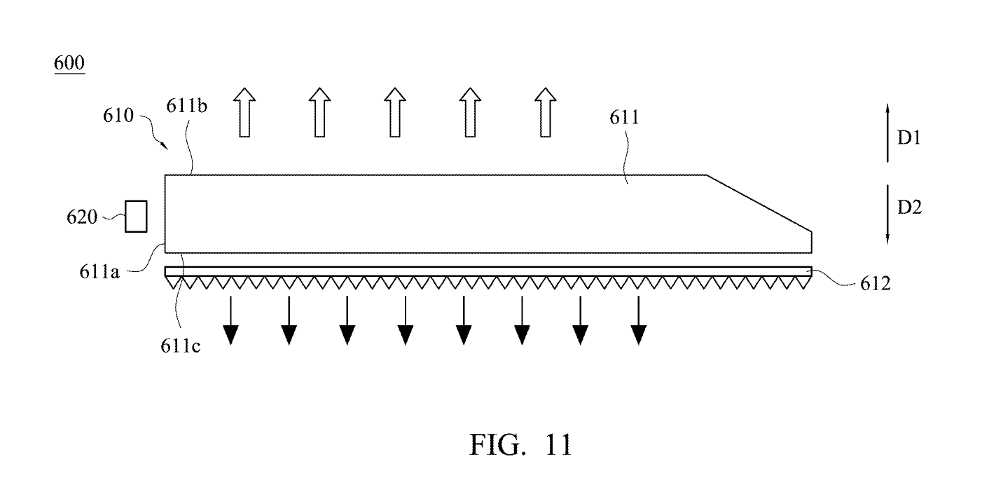

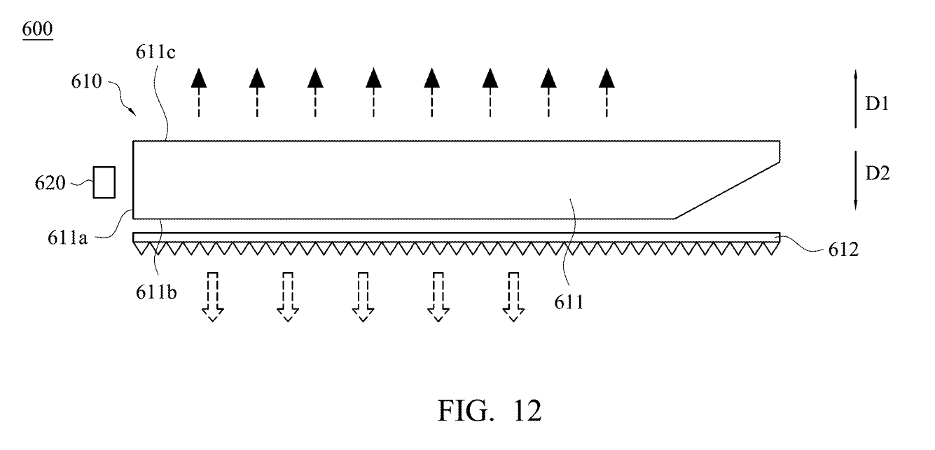

In other embodiments, the light-adjusting member can be a prism film which has a function of changing light directivity. Simultaneously referring to FIG. 11 and FIG. 12, FIG. 11 and FIG. 12 are schematic diagrams showing a light-emitting device 600 respectively disposed in a first arrangement and a second arrangement in accordance with a sixth embodiment of the present invention. The light-emitting device 600 of the present embodiment mainly includes a light guide plate 610 and a light source 620. The light guide plate 610 includes a main body 611, and the main body 611 has a light-incident surface 611a, a first light-emitting surface 611b and a second light-emitting surface 611c. The first light-emitting surface 611b and the second light-emitting surface 611c are respectively connected to two opposite sides of the light-incident surface 611a. The light source 620 is disposed adjacent to the light-incident surface 611a, so as to emit light into the light guide plate 610.

The light guide plate 610 of the present embodiment includes a light-adjusting member, and the light-adjusting member includes a prism film 612 which is disposed on the second light-emitting surface 611c. Therefore, after light is emitted from the second light-emitting surface 611c and passes through the prism film 612, light directivity is changed, such that a first directional property of light emitted from the first light-emitting surface 611b is different from a second directional property of light emitted from the prism film 612.

In some embodiments, the arrangement of the light-emitting device 600 can be changed by forming the light guide plate 610 of the light-emitting device 600 in different configurations, thereby generating different light-emitting effects. As shown in FIG. 11, when the light-emitting device 600 is disposed in the first arrangement, the light guide plate 610 is formed in the first configuration, in which the first light-emitting surface 611b of the light guide plate 610 faces towards the first direction D1, and the second light-emitting surface 611c of the light guide plate 610 faces towards the second direction D2. Moreover, the prism film 612 is disposed on the second light-emitting surface 611c, so that the light guide plate 610 has a first light-emitting function towards the first direction D1 and a second light-emitting function towards the second direction D2. Referring to FIG. 12, when the light-emitting device 600 is disposed in the first arrangement, the light guide plate 610 is formed in the second configuration, in which the first light-emitting surface 611b of the light guide plate 610 is faced towards the second direction D2, and the second light-emitting surface 611c of the light guide plate 610 is faced towards first direction D1. Moreover, the prism film 612 is disposed on the first light-emitting surface 611b, so that the second light-emitting function of the light guide plate 610 towards the second direction D2 and the first light-emitting function of the light guide plate 610 towards the first direction D1 are changed.

In other embodiments, when the light-emitting device 600 is disposed in the first arrangement, the prism film 612 is disposed on the second light-emitting surface 611c. Moreover, when the light-emitting device 600 is disposed in the second arrangement, the prism film 612 is disposed on the first light-emitting surface 611b, so that the first light-emitting function of the light guide plate 610 towards the first direction and the second light-emitting function of the light guide plate 610 towards the second direction can be changed. In some embodiments, the prism film 612 includes a first prism film and a second prism film. When the light-emitting device 600 is disposed in the first arrangement, the first prism film is disposed on the first light-emitting surface 611b, and the second prism film is disposed on the second light-emitting surface 611c. When the light-emitting device 600 is disposed in the second arrangement, the first prism film is disposed on the second light-emitting surface 611c, and the second prism film is disposed on the first light-emitting surface 611, so that the first light-emitting function of the light guide plate 610 towards the first direction and the second light-emitting function of the light guide plate 610 towards the second direction can be changed.

According to the aforementioned embodiments of the present invention, the first light-emitting function of the light-emitting device towards the first direction and the second light-emitting function of the light-emitting device towards the second direction can be changed by varying an orientation and/or a configuration of the light guide plate, such as changing the orientation in which the light guide plate is situated or adding the light-adjusting member to the light guide plate. Therefore, a user may change different light-emitting functions by adjusting the arrangement of the light-emitting device, so as to meet multiple the users' requirements.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light-emitting device, comprising:
a light guide plate comprising a main body, wherein the main body has a light-incident surface; and
a light source disposed adjacent to the light-incident surface;
wherein the light-emitting device is selectively disposed in one of different arrangements;
wherein when the light-emitting device is disposed in a first arrangement, the light-emitting device is able to provide a first light-emitting function towards a first direction and to provide a second light-emitting function towards a second direction; and
wherein when the light-emitting device is disposed in a second arrangement, the second light-emitting function towards the second direction is changed, and the first light-emitting function towards the first direction is also changed.

2. The light-emitting device of claim 1, wherein the main body further comprises:
a first light-emitting surface connected to the light-incident surface, wherein the first light-emitting surface has the first light-emitting function; and
a second light-emitting surface connected to the light-incident surface and opposite to the first light-emitting surface, wherein the second light-emitting surface has the second light-emitting function.

3. The light-emitting device of claim 2, wherein the light guide plate further comprises a plurality of first reflecting structures disposed on one of the first light-emitting surface and the second light-emitting surface.

4. The light-emitting device of claim 3, wherein the light guide plate further comprises a plurality of second reflecting structures disposed on the other one of the first light-emitting surface and the second light-emitting surface, and an inherent type or an arrangement density of each of the second reflecting structures is different from an inherent type or an arrangement density of each of the first reflecting structures.

5. The light-emitting device of claim 1, wherein the light guide plate further comprises an inclined structure disposed on one end of the main body away from the light-incident surface, wherein the inclined structure has an inclined surface, and the inclined surface is inclined relative to the first light-emitting surface and the second light-emitting surface.

6. The light-emitting device of claim 5, wherein the light guide plate further comprises a third reflecting structure disposed on the inclined surface.

7. The light-emitting device of claim 1, wherein
when the light-emitting device is disposed in the first arrangement, the first light-emitting surface of the light guide plate faces towards the first direction and the second light-emitting surface faces towards the second direction; and
when the light-emitting device is disposed in the second arrangement, the first light-emitting surface of the light guide plate faces towards the second direction and the second light-emitting surface faces towards the first direction.

8. The light-emitting device of claim 1, wherein the second light-emitting function is different from the first light-emitting function, and the second direction is different from the first direction.

9. The light-emitting device of claim 8, wherein
the first light-emitting function involves a first luminous property, a first chromaticity property and a first directional property;
the second light-emitting function involves a second luminous property, a second chromaticity property and a second directional property; and
the second light-emitting function is different from the first light-emitting function in that at least one of the first luminous property, the first chromaticity property and the first directional property is different from at least one of the second luminous property, the second chromaticity property and the second directional property.

10. The light-emitting device of claim 1, wherein
the main body further has a first light-emitting surface and a second light-emitting surface, wherein the first light-emitting surface is connected to the light-incident surface, and the second light-emitting surface is connected to the light-incident surface and is opposite to the first light-emitting surface; and
the light guide plate further comprises at least one light-adjusting member, and the at least one light-adjusting member is disposed on the first light-emitting surface and/or the second light-emitting surface, so as to provide the first light-emitting surface with the first light-emitting function, and the second light-emitting surface with the second light-emitting function.

11. The light-emitting device of claim 10, wherein the light-adjusting member comprises a first optical film disposed on one of the first light-emitting surface and the second light-emitting surface, and the first optical film comprises a plurality of first optical structures.

12. The light-emitting device of claim 11, wherein the light-adjusting member further comprises a second optical film disposed on the other one of the first light-emitting surface and the second light-emitting surface, and the second optical film comprises a plurality of second optical structures, wherein an inherent type or an arrangement density of each of the second optical structures is different from an inherent type or an arrangement density of each of the first optical structures.

13. The light-emitting device of claim 10, wherein the light-adjusting member comprises at least one prism film disposed on a side of the first light-emitting surface and/or a side of the second light-emitting surface.

14. The light-emitting device of claim 10, wherein the light-adjusting member comprises at least one color filter disposed on a side of the first light-emitting surface and/or the second light-emitting surface.

15. The light-emitting device of claim 10, wherein the light guide plate further comprises an inclined structure disposed on one end of the main body away from the light-incident surface, wherein the inclined structure has an inclined surface, and the inclined surface is inclined relative to the first light-emitting surface and the second light-emitting surface.

16. The light-emitting device of claim 15, wherein the light guide plate further comprises a third reflecting structure disposed on the inclined surface.

17. The light-emitting device of claim 10, wherein
when the light-emitting device is disposed in the first arrangement, the first light-emitting surface of the light guide plate faces towards the first direction and the second light-emitting surface faces towards the second direction; and
when the light-emitting device is disposed in the second arrangement, the first light-emitting surface of the light guide plate faces towards the second direction and the second light-emitting surface faces towards the first direction.

18. The light-emitting device of claim 10, wherein the second light-emitting function is different from the first light-emitting function, and the second direction is different from the first direction.

19. The light-emitting device of claim 18, wherein
the first light-emitting function involves a first luminous property, a first chromaticity property and a first directional property;
the second light-emitting function involves a second luminous property, a second chromaticity property and a second directional property; and
the second light-emitting function is different from the first light-emitting function in that at least one of the first luminous property, the first chromaticity property and the first directional property is different from at least one of the second luminous property, the second chromaticity property and the second directional property.
